(19) United States
(12) Patent Application Publication
(10) Pub. No.: US 2010/0241467 A1
(43) Pub. Date: Sep. 23, 2010

(54) SECURE COMMERCE AND ASSET/SUPPLY CHAIN MANAGEMENT SYSTEM

(75) Inventors: Eaden Saw, Columbus, OH (US); Tien-Hsien Chang, Columbus, OH (US); Meng Yi Chang, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: RFMatrix, Inc., San Jose, CA (US)

(21) Appl. No.: 12/280,163

(22) PCT Filed: Feb. 21, 2007
(86) PCT No.: PCT/US07/62499

§ 371 Date: Oct. 27, 2008

(30) Foreign Application Priority Data
Feb. 21, 2006 (TW) 95105805

(51) Int. Cl. G06Q 10/00; G06Q 50/00; G06Q 30/00; G06Q 20/00

(52) U.S. Cl. 705/5; 705/330; 705/27; 705/333; 705/21; 705/17; 705/28

(57) ABSTRACT

A Secure Commerce and Asset/Supply Chain Management system and method provides displaying, commerce, asset management, global logistics, Customs declaration and recycling services for any user at anytime, anywhere with available communication network. Wireless sensors/identifier/computer/communicators, 2D graphic identifier, artificial intelligent and pervasive network communication/computing technologies are used to provide a user/friendly space. The user can interact with the system with mobile/wearable devices, or with movements/sounds made by his/her body. Embedded invisible sensing/computing/communication modules and/or holistic 3D virtual computing can be used to enhance user's experience. Major components of the system include an Intelligent Display Unit (IDU, 1), an Ubiquitous Information System (UIS, 2), a Secure Transport Unit (STU, 3), and a Personal Assistant Unit (PAU, 4).

### FIELD OF THE INVENTION

The present invention relates to systems, methods and apparatus for commerce and asset/supply chain management (customer to machine [C2M], machine to machine [M2M], customer to machine—machine to customer [C2M2M2C]), utilizing such technologies as wireless and mobile identification, sensing and computing, aided with 2 dimensional (2D) graph identification, artificial intelligence, optical sensing, information storage and processing systems, and more particularly, relates to mobile or ubiquitous commerce and management of supply chains using such systems.

### BACKGROUND OF THE INVENTION

### Merchandise ID

Barcode labels are a form of merchandise ID (identification) that have been used for identification/pricing inquiry of most merchandise for more than 20 years. Owing to the continuous development of RF (Radio Frequency) technology, many stores like Wal-Mart have incorporated RFID (RF Identification) in their tracking and inventory control of merchandise at the stores. The RFID tags allow the identification to be read within certain distance without direct view, and allow new data to be written to the tags to record pertinent history/pedigree of the merchandise.

A more recent form of merchandise ID is RFID (Radio Frequency Identification), which generally involves tags on the merchandise, and readers for interacting with the tags. The RF readers/antennas are usually mounted at certain location (such as on the shelf) and, when the merchandise are removed from the location, the reader will sense the information, acquire the product information and display them on-line. However, owing to the price and reliability of tag reading, the application of RFID tags is still somewhat underdeveloped.

Currently, at the store, users need to take the merchandise to a certain stand (cashier) for inquiry of price, and limited information. The stand can bring up the information through reading of the merchandise's barcode. The merchandise's information such as the price, category, and origin of production will then be displayed on the screen.

### Supply Chain Management

A supply chain should include end-to-end management, from the supplier's supplier to the customer's customer. Thus, a total secure supply chain management system should take into account the various players in the supply chain, e.g. the shipper, the consignee, the warehouse, trucker, logistics agents, customs brokers and carriers, in the case of import/export. Today, there exist many types of manufacturing database management and inventory control systems. However, each of these systems only aim to provide a solution that relates to their own operation. This presents a significant problem in total seamless supply chain management, not to mention a number of security concerns.

There exists a need for a secure commerce and asset/supply chain management system and method (techniques) which can provide displaying, commerce, asset management, global logistics, Customs declaration and recycling services for any user at anytime, anywhere with available communication network.

There is a need to address the limitations of the prior art systems from the very beginning of the supply chain, paying particular attention to a customer's interests and concerns. That is, there is a need to provide a total system, from receiving the order, until the order arrives at the customer's house, and the reverse logistics, when some of the orders need to be returned to the manufacture.

### SUMMARY OF THE INVENTION

According to the invention, generally, a Secure Commerce and Asset/Supply Chain Management system and method provides displaying, commerce, asset management, global logistics, Customs declaration and recycling services for any user at anytime and anywhere with the currently available communication network. Wireless sensors/identifier/computer/communicators, 2D graphic identifiers, artificial intelligent and pervasive network communication/computing technologies are used to provide a user/friendly space. The user can interact with the system of the invention with mobile and/or wearable devices, or with movements and/or sounds made by his/her body. Embedded invisible sensing/computing/communication modules and/or holistic 3D virtual computing can be used to enhance user's experience.

Generally, the present invention utilizes various information/communication security technologies to provide top security and privacy to authenticate and protect users for their interactions and transactions conducted with the system. The system includes: (1) Intelligent Display Units (IDU hereafter) that interact with users; (2) Secure Transport Units (STU hereafter) with wireless ID enabled for network communication to seal the shipping articles and to track their movement in real-time to ensure secure end-to-end shipments; and (3) Ubiquitous Information Systems (UIS) to manage C2M, M2M, C2M2C, C2M2M2C interaction between users and any units of this system or between the units in this system and/or with the other communicational devices.

The UIS may also be used to manage the display of contents for the merchandise/service; the databases for commercial/personal information including but not limited to the user's information, clicking count, orders, payments; and logistics management including but not limited to the shipments, logistics/reverse logistics, product pedigree, and Customs information, etc. The merchandise/service may be securely tracked and managed, and the marketing information including user's behaviors and user's preferences are analyzed for feedback. Goods/assets can be identified with RFID and/or 2D graphic coding. The system/method/apparatus can be used by anyone at anyplace with mobile or worn or implanted devices/modules and available communication network.

All the displaying information, video for the product demonstration, price, and promotional activities, etc., can be updated real-time from the UIS system.

The system is user friendly, intelligent, invisible, mobile, and silent. The system provides seamless connections with invisible IO (input/output), embedded computers, and wireless sensor modules. The system provides direct human interface that can be operated without touching any of the equipment. The system is location oriented and integrates many modern communication, and Internet technologies, including but not limited to:
Wireless devices: RFID tags and readers, BlueTooth, Wi-Max (GPRS), and wireless sensor modules that can be wearable or implantable;
Sensors: Passive and proactive, requiring low power consumption, invisible, embedded; able to sense light, heat, motion, proximity, etc.;
Processors: Miniature, embedded, invisible intelligent processors (Computers);
2D graphical ID and the corresponding software system: Artificial intelligence, voice commanding, motion commanding, etc.;
Wireless Network Communication: GSM, GPRS, WAP, SMS, CDMA 2000 1x, EDGE, WCDMA, CDMA 2000 3X, XML, UMTS, Satellite communication;
Network Computing Mobile IPv6, with u-Network+Intelligent Environment, WWW, Java, WAP, XML, Web 2.0, SOA;
RFID Middleware: Sensor Network Applications, GRID, WLAN (Bluetooth, RF I/F), Wireless Near LAN, Sentient Computing, Nomadic Computing, 2D coding system P2P/Grid, Ubiquitous Network; and
Information Security Technologies: Personal Security, 3D authentication, PKI, encryption, biometric identification.

### The Intelligent Display Unit (IDU)

A person (customer) at a public or private space engages an intelligent display, is greeted with personalized information and starts the C2M interaction. The C2M interaction can be accomplished by typing the keyboard, by sending message from his mobile/wearable devices, by speaking to the display, by touching the displayed merchandise/service, by touching a screen, and/or by signaling with movements of his/her body. The display will automatically demonstrate the merchandize/service of interest, with various views, functions, and aspects of the merchandize/service, addresses the customer's questions/concerns, or engage the customer into a virtual experience of the merchandise/service. The customer (person) can copy some of the displayed information into his mobile device (or wearable device) by dragging it or let it flow into his device adjacent to the screen. He can order the merchandise/service and complete the transaction with various payment methods. There is a 2d graphical identifier of the merchandise. He can take a photo of this graphical identifier with his mobile device and send the image through the network whereby his merchandise is ordered. He can also send the image to the others for them to place order.

Payment is completed by automatic deduction from the user's credit card, bank account, e-wallet, or mobile banking account with credit cards, smart cards, mobile devices, . . . etc. A POS (point of sale) system can be attached or built into the unit, or the transaction can be virtually accomplished through wireless communications.

Merchandise to be sold can be products for personal use, gifts, or for reselling. It can be tickets for air, train, or MRT transportations, or for tourist attractions, or entertainment events (music, movie, show, etc.). It can also be used for reservations for taxi/limousine or hotels, or it can be used for advertisement, promotion, or information/educational. The user can purchase other services including ordering public available information, e.g. airplane schedules, or conducting voice or video conferencing with a remote person through interacting with the display. The conference can also be augmented with virtual 3D or sport 3D holographic display.

The system can take orders from the person and complete the money transactions with the POS system. The POS system can take electronic payments. The POS can accommodate legacy credit cards/RF credit cards/ATM cards/smart cards/mobile devices or any device build in with money credit or can be linked to a personal financial account for payment. Such cards/devices can comprise means of identification for security purposes.

Upon completion of the transaction, receipts/tickets/unique tracking IDs (or Unique Consignment Reference number for export goods) are issued in electronic form. The latter can be transmitted to the mobile device carried by the person, and/or printed out by a printer attached to the system. The merchandise will be placed in a secure transport unit, locked with a tamper-proof, wireless locking mechanism carrying a non-reusable, unique ID (RFID or UCR [Uniform Consignment Reference]), and deliver to a desired location.

If necessary (i.e., if appropriate), a taxi will be waiting at or dispatched to the location where the reservation order is issued or some other requested location. Similarly, a hotel room may be reserved under the user's name and a limousine ready to pick up this person.

If the order involves exporting, the system will automatically handle Customs declaration and licensing activities.

The system is equipped with an anti-theft mechanism, which will detect when any merchandise is moved away from the designated area. An alarm system will be triggered to set off various sirens, voice messages, and/or warnings. Alarm messages can also be sent through e-mails/mobile devices, to the person, to management and/or to police agencies so that proper measures can be taken.

A mechanism is linked to the system for returning/recycling defective/used/old merchandise. The user will have to request RMA No. (return merchandise authorization number) electronically; the returning items can be taken with RMA codes issued by the backend or central control system authorized by the administrator and identification of the returning item. A credit for the item will be issued electronically to their (the user's) finance account or their credit account. Again, hard copy can be printed out for future reference and the reverse inventory is updated at the backend system. Defective merchandise will be transported back to the seller, following a reverse logistics path.

A recycling mechanism is linked to the sellers/manufacturers/environmental agencies based on the procedures/guidance provided by the seller/manufacturer/environmental agencies or international guidance. The recycled units will then be packed automatically and shipped back to the manufacturer.

### The Secure Transport Unit (STU) and Transport Tracking

A Secure Transport Unit (STU) is used to lockup the goods/documents in transit. The STU can be any size, from small box to large containers. Each STU is equipped with a tamper-proved wireless lock (e.g. RFID) bearing an SSCC (Serial Shipping Container Code) A mechanism is also available to ensure the safety of the merchandise/article before and in-transit.

For antiterrorism and cargo tracking, the World Customs Organization (WCO) suggests that every country use UCR to resolve information management issues for international cargo logistics.

Upon completion of a purchase, an electronic tracking # (or UCR for exporting cargoes) will be routed to the seller/warehouse to signify the confirmation of the purchase. This number will be linked to the SSCC code of the STU that holds the merchandise for delivery to the designated location. This tracking code will follow the cargo conveyance all the way until the cargo is received by the consignee and will allow the merchandise/cargo to be tracked real-time.

### Ubiquitous Information System (UIS)

The Ubiquitous Information Systems (UIS) is the central information control system used here to manage all the C2M, M2M, C2M2C, C2M2M2C interaction between users and any units of this system or between the units in this system and/or with the other communicational devices. There are three major functions of the UIS.

1. Manage/Update all the Displaying Information

The UIS is used to manage/update all the displaying information, video for the product demonstration, price, and promotional activities . . . etc, real-time and manage the databases for commercial/personal information including but not limited to the user's information, clicking count, orders, payments. The system is connected with banks for ease of monetary exchange to enable payment, loans, and money transfer during transaction. The UIS is also used to perform logistics management/tracking, including but not limited to the shipments information, logistics/reverse logistics, product pedigree, and Customs information, . . . etc.

2. Manage the Cargo Logistics/Supply Chain

The system issues a unique tracking number/or UCR for the goods/cargoes when an order is received. The system is linked to the logistics service agents, and provides commands to specify the products, its package or desired gift wrap, shipped to a desired location. The tracking number/UCR is then logged in the systems' database and initiate a real-time tracking process. The system can provide additional cargo logistics and supply chain management service, including but not limited to: management for invoice, inventory control and reordering, vendor management, reverse inventory and recycling, the system is connected to logistics express service and can handle global shipment to anywhere in any form.

The UIS can be linked to the national or international Single Window/e-government/e-trading/e-traffic platform and serve as a global ordering & logistics service center. The system can provide intelligent Information routing/connection with national governmental and non-governmental platforms.

The system can provide international Customs declaration/licensing services when export process is involved. The licensing service can include certificate of origin, certificate for intellectual property, a mark for AEO (authorized economic operator) if the manufacturer has been certified, and other certification might be involved . . . etc. Then a tracking process through the entire process is conducted. The manufacture process information of the goods/or the pedigree can be recorded with certain identification (RFID, barcode, etc.) and linked to the same database. The users or any concerned party can track the location and status of the goods and the pedigree of the goods any time, anywhere during transit.

### Marketing Analyses/User Behavior Study

The UIS can provide marketing analyses and consumer behavior study. People's feedback/showing interest (CRM), sales, and inventory information on particular merchandise are collected real-time and maintained on a database. This information will be used for future marketing analyses/users behavior study, to be feedback to the manufacturer/management for revising/fine-tuning future marketing approach in order to provide a better service.

Promotion item of their preference can also be sent to them via short message, their prefer interaction mechanism will be triggered preferentially at the IDU with personalized greetings when they approaches the IDU. The users' concerns/request expressed to the IDU regarding the merchandise/services will be collected and added to future product demonstration. Their questions will also be summarized to better serve them.

Consumer Behavior Study is the study of the processes involved when individuals or groups select, inquiring, purchase, use, or dispose of products, services ideas, or experiences to satisfy needs and desires. The consumer's behavior pre-purchase, purchase, and post-purchase can shine some light to the manufacturer for future product development/promotion.

### Information Security Measures

The database is guarded with top security from any form of intrusion. The people's privacy will also be preserved.

### Ubiquitous Network

The system can be used anytime, at any location, including but not limited to following places: exhibition place, commercial, entertainment, hotels, restaurants, government or non-governmental places, sea, land, air transportation and their stations, medical treatment locations, residents, sports facilities, streets, underground streets, sub, factories, rural, wild area . . . etc.

### Personal Assistance Unit (PAU)

A smaller unit of IDU can be used for customize personal assistance (PAU). The unit can be used at offices/or at any private space to assist business/individual organizing/their tasks, managing their assets, documents, information, and all their ordering needs. The PAU allows people to locate the right asset, provide information about the current physical status of an asset, and keep an information history of an asset. All the items they need to manage can bear a RFID. Their PAU can be equipped with a talking Kiosk building with camera and microphone for motion/voice commanding. They can request the system to give them information regarding the location of their assets, the weather and stock market situation, the location of other members, the status of goods they ordered, print any images/documents they want with voice, keep track of their concerns and preferences, summarize their routine activities for them, analyze/manage the resources for them, alarming them for their health conditions, the system can also be linked to the surveillance system and help them monitor for any unwanted intrusion hazardous event. A robot build in with sensors can also be used to take care of the chores including organizing assets/books/documents/equipments to designated place and to routinely cleanup areas. The robotic devices can accomplish any of the functions mentioned in this system or to extend the functions.

According to the invention, a Secure Commerce and Asset/Supply Chain Management system comprising: an Intelligent Display Unit (IDU, 1); an Ubiquitous Information System (UIS, 2); a Secure Transport Unit (STU, 3); and a Personal Assistant Unit (PAU, 4).

Further according to the invention, the Intelligent Display Unit (IDU, 1) provides direct customers/users interaction.

Still further according to the invention, the Ubiquitous Information System (UIS, 2) works at the backend to provide all the digitized information and to record customer's behavior real time for future marketing purpose; once an order is placed at the IDU (1), the UIS (2) receives the order information, issues a UCR both to the customer at IDU (1) and a route to the shipping agent, and the merchandises/cargoes are then locked in the STU (3), shipped on the road and tracked real-time with satellite+GPRS+WSN or the other available wireless communication technologies until they reach the designation.

Yet further according to the invention, the PAU (4) can assist individual/office asset management, and can also access the other units mentioned here for any purchase/tracking needs.

Also according to the invention, the IDU (FIG. 3) comprises at least selected ones of: wireless reading module (10), communication module (12), position module (14), power supply module (16), RFID reader antenna (18), communication antenna (20), position antenna (22), power supply device (30), LCD display (32), memory slot (320) for memory Card (322), Geographic Information System (34), Dynamic Real Time Merchandize Tracking Database (36), POS System (38), Anti-Theft police network system (40), Motion Recognition/Commanding System (44), Face Recognition System (46), Voice Recognition/commanding System (48), Printer/User ID generator (50), Embedded sensor/computer/communicator (52), and Return/Recycling System (54).

Further according to the invention, a display control system (FIG. 2) comprises at least one wireless reading module (10), one communication module (12), one position module (14), one power supply module (16), one RFID reader antenna (18), a communication antenna (20), and a position antenna (22).

Still further according to the invention, the display control system (FIG. 2) is used to control the interaction with the users, manage the merchandise, communicate with the UIS, and the other machines as needed to fulfill the user's requirements.

Yet further according to the invention, the power supply module (16) is connected to an external power supply to provide power to the wireless reader module (10); the wireless reader module (10) is connected to the RFID antenna (18) and power supply (16), to read one or more external RFID signals from RFID tags; and the communication module (12) is connected to power supply (16) and to the antenna (20), to transmit the RFID signal information, the position module (14) is connected to the position antenna (22) and to the power supply (16).

Also according to the invention, the communicational module (12) comprise a communication module (IC) selected from the group consisting of Global System For Mobile Communications (GSM), Code Division Multiple Access (CDMA), DCS Personal Communications Services (PCS), 3G (3rd Generation), and Wireless LAN (WLAN).

Further according to the invention, the position module (14) comprises one or more of Global Positioning System (GPS), Asymmetric Global Positioning System (AGPS), Global Orbiting Navigation Satellite System (GLONASS), North Pole position system, or Galileo commercial position navigation system, and may also be a combination of GPS and wireless network to provide the location information of the merchandise/assets/IDU.

According to the invention, a Secure Commerce and Asset/Supply Chain Management method comprises providing an Intelligent Display Unit (IDU, 1); providing an Ubiquitous Information System (UIS, 2); providing a Secure Transport Unit (STU, 3); and providing a Personal Assistant Unit (PAU, 4).

Further according to the invention, a person (customer) at a public or private space engages with the IDU, is greeted with personalized information, and starts a C2M interaction.

Yet further according to the invention, the C2M interaction can be accomplished by typing a keyboard, by sending a message from the person's mobile/wearable devices, by speaking to the display, by touching the displayed merchandise/service, by touching a screen, or by signaling with movements of his/her body.

Still further according to the invention, the display automatically demonstrates the merchandize/service of interest, with various views, functions, and aspects of the merchandize/service, addresses the customer's questions/concerns, or engage the customer into a virtual experience of the merchandise/service.

Also according to the invention, payment is completed by automatic deduction from the user's credit card/bank account/e-wallet, or mobile banking account with credit cards/smart cards, mobile devices, . . . etc.

Further according to the invention, a POS (point of sale) system is incorporated into the display unit wherein the system can take orders from the person and complete the money transaction with the POS system.

Yet further according to the invention, upon completion of the transaction, receipts/tickets/unique tracking IDs (or Unique Consignment Reference number for export goods) are issued in electronic form, which can be transmitted to the mobile device carried by the person, and/or be printed out by a printer attached to the system.

Still further according to the invention, the merchandise is placed in a secure transport unit, locked with a tamper-proved wireless locking mechanism carrying a non-reusable, unique ID (RFID or UCR), and delivering the merchandise to the user's desired location.

Further according to the invention, a taxi is dispatched to a location where the reservation order is issued or another requested location.

Also according to the invention, the method comprises reserving a hotel room with the user's name.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

FIG. 1 is a representation of the four major components in this invention (IDU 1, UIS 2, STU 3, PAU 4);

FIG. 2 is the Intelligent Display Control System, according to the invention;

FIG. 3 is the 1st Intelligent Display Unit, according to the invention;

FIG. 4 is the first physical demo of the Intelligent Display System (Unit), according to the invention;

FIG. 5 is the flow chart for the operation of the 1st Intelligent Display Unit in this invention

FIG. 6 is the next Generation Physical Demo of the Intelligent Display Unit, illustrating personalized interaction with the IDU, according to the invention;

FIG. 7 is the Next Generation Intelligent Display Unit, according to the invention;

FIG. 8 is the Flow chart for the Next Generation Intelligent Display Unit, according to the invention;

FIG. 9. is the The Secure Transport Unit and the Export Cargo Routs export through the boarder to another country, end-to-end security is monitored all the time, according to the invention;

FIG. 10 is the Flow chart for the interaction between STU and UIS, according to the invention;

FIG. 11 is the Sensor Mesh, according to the invention;

FIG. 12 is the Ad Hoc Network, according to the invention; and

FIG. 13 is the GRID network, according to the invention.

### DETAILED DESCRIPTION OF THE INVENTION

Generally, the invention aims to provide a total solution for commerce and assets/cargo logistics management.

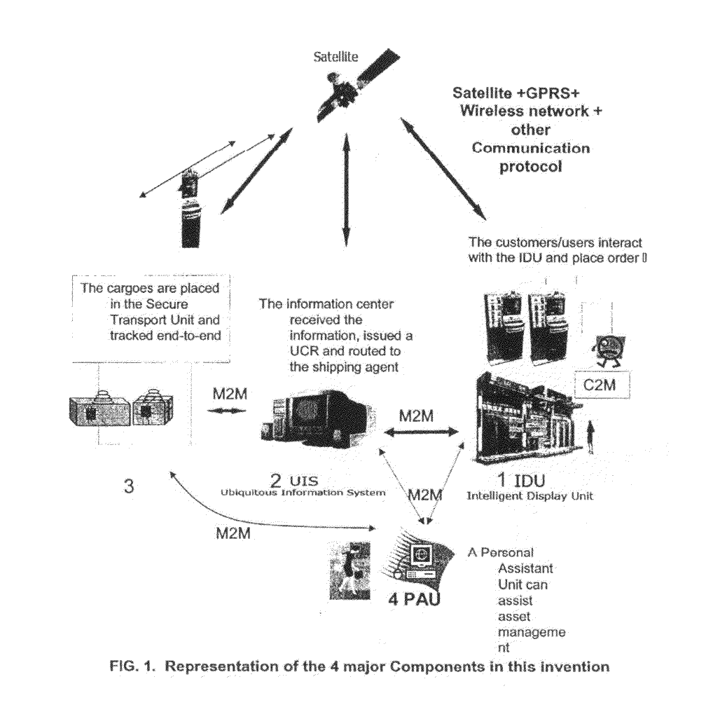

FIG. 1 (“Representation Of The 4 Major Components In This Invention”) illustrates, generally, the major components of the invention, and their relationship with one another in an operating environment. The four major components are:

Intelligent Display Unit (IDU) 1,

Ubiquitous Information System (UIS) 2,

Secure Transport Unit (STU) 3, and

Personal Assistant Unit (PAU) 4.

The Intelligent Display Unit (IDU) 1 provides direct customers/users interaction. It is equipped with all the intelligent devices to make the customer's experience unforgettable. The Ubiquitous Information System (UIS) 2 works at the backend to provide all the digitized information and to record customer's behavior real time for future marketing purpose. Once an order is placed at the IDU 1, The UIS 2 receives the order information, issues a UCR both to the customer at IDU 1 and issues a route to the shipping agent. The merchandises/cargoes are then locked in Secure Transport Unit (STU) 3, shipped on the road and tracked real-time with satellite+GPRS+WSN or the other available wireless communication technologies until they reach the designation. The Personal Assistant Unit (PAU) 4 can assist individual/office asset management, can also access the other units mentioned here for any purchase/tracking needs.

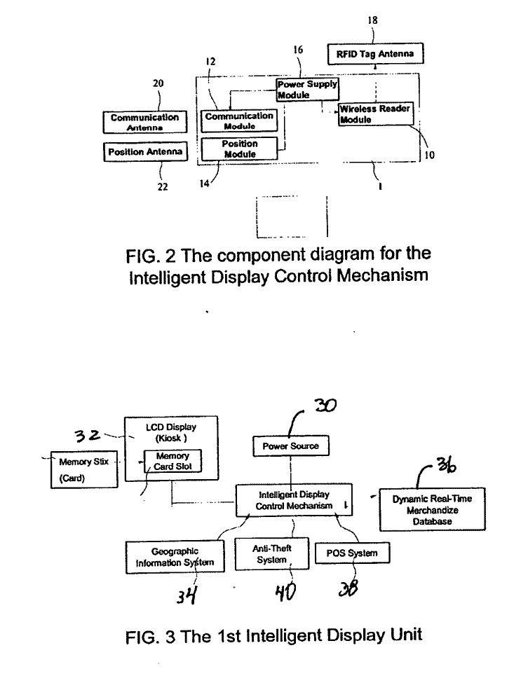

FIG. 2 illustrates components of the Intelligent Display Control Mechanism (System), and FIG. 3 illustrates a 1st Intelligent Display Unit (IDU 1), the elements of which include at least selected ones of: wireless reading module 10, communication module 12, position module 14, power supply module 16, RFID reader antenna 18, communication antenna 20, position antenna 22, power supply device 30, LCD display (such as a touch screen kiosk) 32, memory slot 320 for memory Card 322, Geographic Information System 34, Dynamic Real Time Merchandize Tracking Database 36, POS System 38, Anti-Theft police network system 40, Motion Recognition/Commanding System 44, Face Recognition System 46, Voice Recognition/commanding System 48, Printer/User ID generator 50, Embedded sensor/computer/communicator 52, and Return/Recycling System 54.

FIG. 2 (“The component diagram for the Intelligent Display Control Mechanism”) illustrates an intelligent control mechanism (“display control system”) for implementing what is described in FIG. 1, as follows. The display control system includes at least one wireless reading module 10, one communication module 12, one position module 14, one power supply module 16, one RFID reader antenna 18, a communication antenna 20, and a position antenna 22. The display control system is used to control the interaction with the users, manage the merchandise, communicate with the UIS, and the other machines as needed to fulfill the user's requirements.

The power supply module 16 is connected to an external power supply to provide power to the display control system 3 (FIG. 3), wireless reader module 10. The wireless reader module 10 is connected to the RFID antenna 18 and power supply 16, to read one or more external RFID signals from RFID tags. The communication module 12 is connected to power supply 16, and antenna 20, to transmit the RFID signal information, the position module 14 is connected to position antenna 22 and power supply 16, the signal is transmitted to position the intelligent display control 3, the display control system can be set at a fix position or on a moving objects as explains in more detail in the following example.

The communicational module 12 may comprise various communication modules (IC): Global System For Mobile Communications (GSM), Code Division Multiple Access (CDMA), DCS Personal Communications Services (PCS), 3G (3rd Generation), and/or Wireless LAN (WLAN), . . . etc.

The position module 14 may comprise Global Positioning System (GPS), Asymmetric Global Positioning System (AGPS), Global Orbiting Navigation Satellite System (GLONASS), North Pole position system, or Galileo commercial position navigation system. The position module 14 may also be a combination of GPS, wireless network to provide the location information of the merchandise/assets/IDU.

FIG. 3 illustrates the “intelligent display unit” of this invention. The intelligent display unit generally comprises at least one power supply 30, an intelligent display control device 3 (FIG. 3), an LCD display (kiosk) 32, one geographic information system 34, a real time merchandise status database 36, a POS system 38 and an anti-theft alarm system 40.

In addition, an IC reader mechanism (not shown) can be connected to this system to read information out of smart cards. The smart card can be electronic credit account or I-cash on the market, etc.

The power supply 30 is connected to city power (mains) with a cable, to provide all the power needed for the intelligent display system. The intelligent display control device 1 (FIG. 2) comprises one power supply 16 (FIG. 2), which is connected to power supply 30 (FIG. 3), to provide all the power needed for the intelligent display control device 1 (FIG. 2).

The intelligent display control device 1 of FIG. 2 may comprise a wireless reading module 10, a communication module 12, a position module 14, an RFID antenna 18, a communication antenna 20 and a position antenna 22.

The wireless reader module 10 in the intelligent display control device 1 of FIG. 2 is connected to the RFID tag antenna 18, to read signals from one or more external RFID tags. The communication module 12 is connected to antenna 20 and wireless reader module 10 to transmit the information obtained from RFID tag with one first communication specification, position module 14 is connected to position antenna 22 with a first or second communication specification to define the location of the intelligent display control system 3 of FIG. 3.

The communication module 12 may comprise a communication IC: a GSM, a CDMA, a DCS, a PCS, 3G or wireless network. The position module 14 comprises the communication IC: GPS, AGPS, GLONASS, North Pole position system, or Galileo commercial position navigation system.

The LCD (display) 32 is connected to power supply 30 and the intelligent display control system 3 to display the merchandise information, the LCD 32 has a power supply 16 and a memory set (card/slot) 320. Power supply 16 is connected to power supply 30 to provide the power needed for the LCD 32. The memory card 320 can be inserted into a storage memory 322. The storage memory 322 contains the information of the merchandise, which includes the details and manufacturer information, etc. Memory card 322 can be a regular memory card from the market, a SD (secure digital) or CF (compact flash) card.

The intelligent display unit can be linked to external peripheral devices. It is connected to GIS 34, to provide the position control of the Intelligent Display Control System, and real time connected to merchandise database 36, the database contains the merchandise information.

In addition, the Intelligent Display Unit of this invention can handle selling of the merchandise with POS system 38 wired or wireless and anti-theft monitoring system 40 connected to the Intelligent Display Control system via y-network or series connection. The short distance communication can be achieved via Bluetooth.

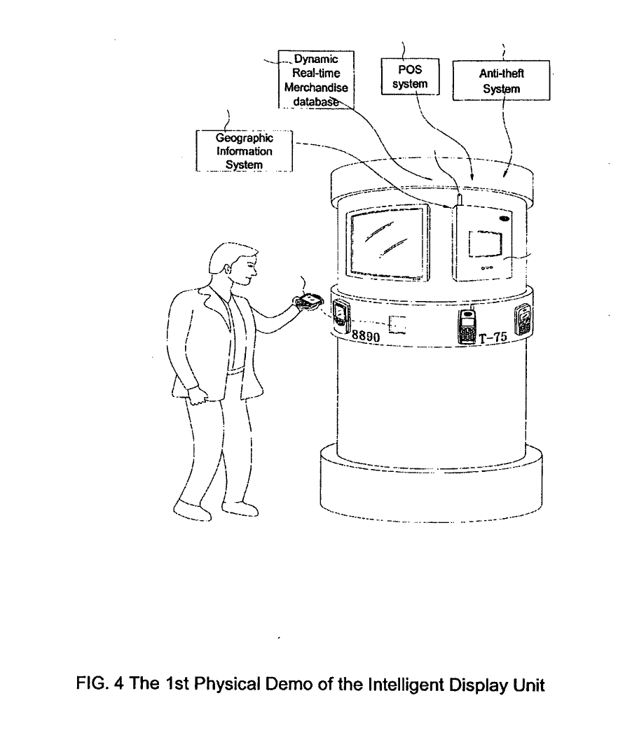

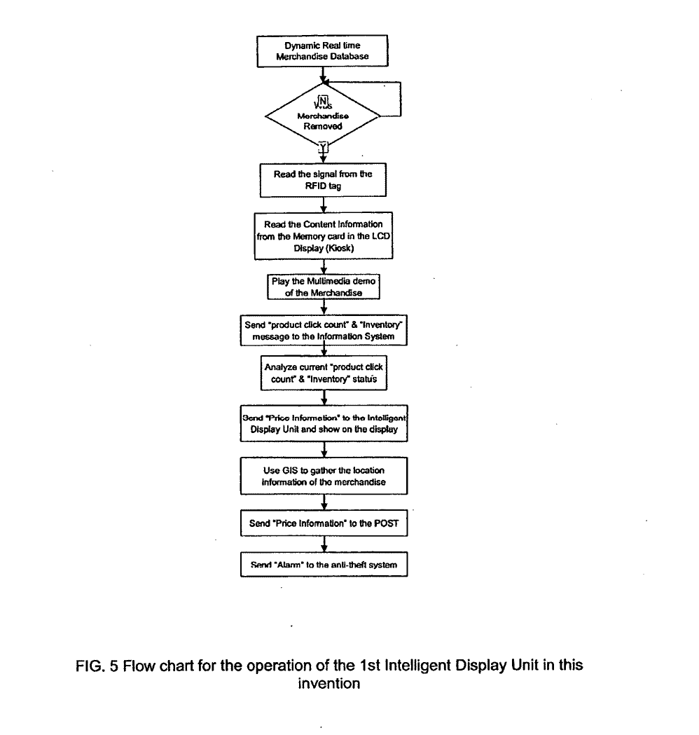

FIG. 4 illustrates a 1st physical demo system of the Intelligent Display Unit (IDU), and FIG. 5 is an operation flow chart of the IDU. The IDU comprises a LCD 32, an Intelligent Display Control system 3 (FIG. 3), and a database 36 for the real-time status merchandise activities. There is also intelligent demo software to enable the operation of the IDU.

The method is described in the flow chart of FIG. 5, wherein steps are designated by reference numerals “S100” through “S120”. The method includes starting the IDU S100 with the operation of the intelligent display software. The IDU can be placed at a fixed fixture or a movable fixture, the IDU detects whether any merchandise have been moved S102, the S102 signal indicates that the merchandise was removed by a consumer from its original location, the signal was received by the RFID antenna 18 (FIG. 2) of the Intelligent Display Control system 3. If the signal is positive, then the wireless reading module 10 of the Intelligent Display Control system 3 will read at least one additional RFID tag from the merchandise pool S104, otherwise, it will continue to perform S102.

The signal produced by the RFID tag 42 (FIG. 4) indicates the information from one of the embedded storage memory of the LCD 32 and produces at lest one multimedia merchandise demo signal of the S106 to at least one of the LCD display 32 and play the multimedia demo of the merchandise through one of the sound output devices not shown) S108.

The intelligent display system also transmits one of the interest/storage information to the real-time analyses database 36 (S110). The real-time dynamic merchandise database 36 will then analyze the status of the merchandises with the number of interest shown (S112). The information will then fed back to the manufacturer of the merchandise for future reference. Then, the price of the merchandise is transmitted to the intelligent display system and play on the LCD 32 (S114)

In addition, the intelligent display system in this invention can also transmit the location signal of the merchandise to the GIS system 34, to follow the location of the merchandise (S116). It can also transmit the merchandise expense signal to a POS system 38 (S118), so that the customer can checkout (purchase) the desired items.

The system can also transmit an alarm signal to the police network 40 (S120). This procedure S120 is intended to prevent theft of certain merchandise. When the merchandise is move beyond the sensed range of the Intelligent Display Control Unit 1, but has not been checked by the POS system 38, the police network system 40 will be triggered and various alarms will be set off. The police station will also be informed of the burglar alarm.

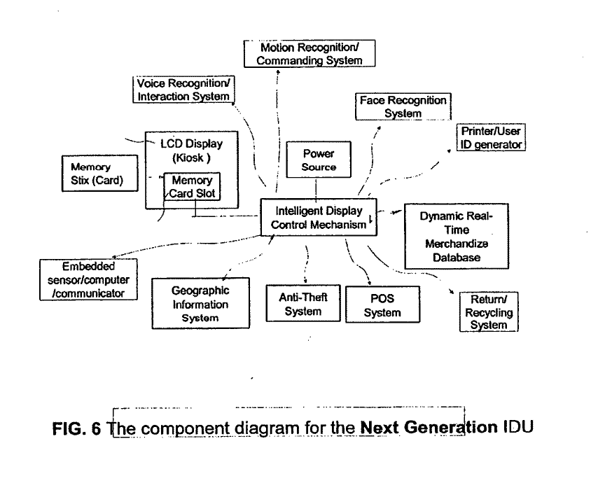

The IDU system illustrated in FIG. 4 can be “upgraded” to provide an innovative personalized C2M interaction/service. The IDU2 is equipped with various artificial intelligence and digital convergence. FIG. 6 illustrates “Next Generation Physical Demo of the IDU” (hereinafter referred to as “IDU2”).

As shown in FIG. 6, a number of additional modules may be added to the IDU to augment the user's experience. The user can now interact with the IDU2 by various methods: typing the keyboard, sending message from his mobile/wearable devices, touching a Kiosk screen, speaking to the display, touching the displayed merchandise/service, or signaling with movements of his/her body.

The LCD display (32) can be replaced with a Kiosk to enable the touch screen user interface. The additional modules may include one, some or all of: motion Recognition/Commanding System 44, Face Recognition System 46, Voice Recognition/interaction System 48, Printer/User ID generator 50, Embedded sensor/computer/communicator 52, and Return/Recycling System 54.

The motion Recognition/Commanding System 44 and face recognition system 46 can both be implemented by an intelligent camera system with support of artificial intelligent computation. With the Motion Recognition/Commanding System 44, users can simply move their eyes, arm, or other part of their body to engage the interaction with IDU2 to address their concerns. Face recognition system 46 will allow IDU2 (FIG. 6) to recognize the user and be able to greet/serve them with personalized service. Voice recognition/commanding system 48 analyze the recorded user's voice to translate their voice to text commands. The preprogrammed responses at IDU2 addressing the user's concern can be announced with a text-to-speech program. One can even choose a known male or female's voice for IDU2.

The embedded sensors/computer/communicator 52 are invisible and yet the user's presence, movements, etc. are sensed and comprehended to allow the IDU2's personalized response to the user.

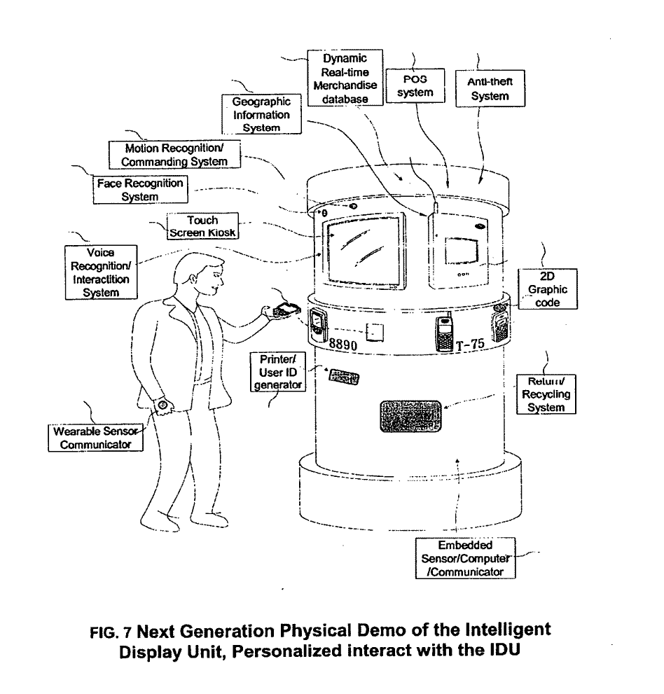

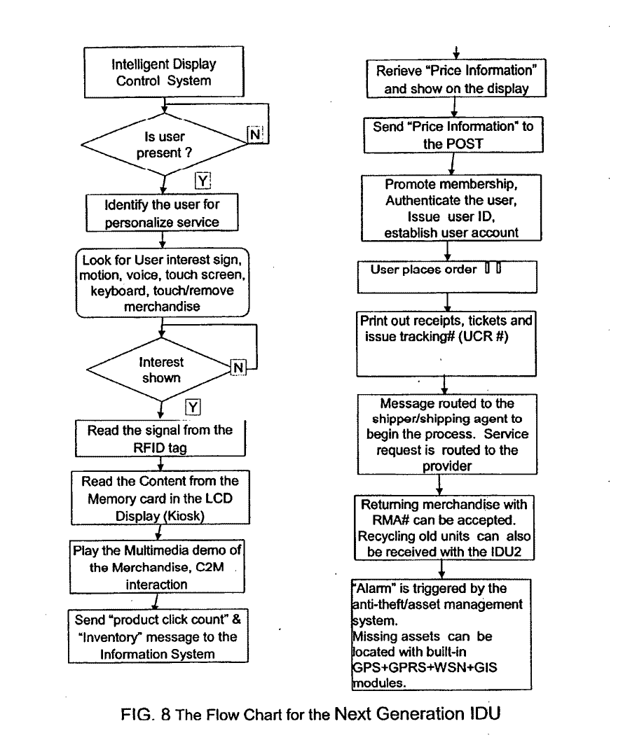

### FIG. 7 and FIG. 8 Flow Chart and the Physical Unit of the Next Generation Intelligent Display Unit (IDU2)

With more artificial intelligent technology, IDU2 can process certain user request automatically. When the embedded sensor senses the presence of a user, indicated by S202, the IDU2 will be turned on and start to identify the user for proving more friendly service S202.

When there is a clear signal that the user shows interest in a merchandise/service (S206), the IDU2 will identify the item of interest (S208) and read the demo content from the memory card (S212), and start the demo of the merchandize/service (S214). various views, functions, and aspects of the merchandize/service can be requested by requesting directly through the IDU2 (a C2M, customer to machine communication). Digital convergent computing can allow the user to be engaged into a virtual experience of the merchandise/service. Wireless communication plus digital convergent technology also allows the user to drag some of the displayed information into his mobile device (or wearable device) or let it flow in his device adjacent to the screen. The IDU2 will send a signal “click count for the merchandise” together with a report for inventory status to the UIS database (S216), also retrieve price information of the merchandise/service and show on the display (S218), also send the information to the POS system (S220).

IDU2 can then invite the user to join the membership, take some authentication parameters from the user, and issue a user ID (S222).

Several authentication techniques can be used here: PKI, password, or biometric technology such as fingerprint, face, iris, voice, vein pattern recognition, . . . etc. The user's account can be established via issuing a 2D graphic code. The 2D graphical code and the backend middleware system allows rapid identification of people, object, advertisement, . . . etc. The image can also be transmitted to the IDU via mobile devices and the user can complete the transaction without sale people's intervention (S224). The image of this graph can also been sent to a remote person with a mobile device for them to place order.

A POS system attached/built in to the IDU allows payment to be automatic deducted from the user's credit card/bank account/e wallet, or mobile banking account with credit cards/smart cards, mobile devices, etc, or the transaction can be virtually accomplished through wireless communications.

Upon completion of the transaction, receipts/tickets/unique tracking IDs (or Unique Consignment Reference number for export goods) are issued in electronic form, which can be transmitted to the mobile device carried by the person, and/or be printed out by a printer attached to the system (S226). A message will be send to the shipper/shipment agent to initiate the secure shipment process (S228).

Taxi will be waiting at the location where the reservation order is issued or the other requested location. Hotel room is reserved with the user's name and the Limousine is ready to pick up this person.

The merchandise will be placed in a secure transport unit, locked with a temper-proved wireless locking mechanism carrying a non reusable, unique ID (RFID or UCR), and deliver to his desired location.

A return/recycling mechanism is linked to the system for returning/recycling the defective/used/old merchandise. The user will have to request RMA # electronically; the returning items can be taken with RMA codes issued by the backend or central control system authorized by the administrator and identification of the returning item (S230). The returned merchandise will follow a reverse logistic route, either be put back on the shelf or be shipped back to the supplier depend on the agreements. Credit to the item will be issued electronically to their finance account or their credit account. Again, hard copy can be printed out for future reference and the reverse inventory is updated at the backend system. Defective merchandise will be transported backed to the seller follow reverse logistics path.

Recycling mechanism is linked to the sellers/manufacturers/environmental agencies based on the procedures/guidance provided by the seller/manufacturer/environmental agencies or international guidance. The recycled units will then be packed automatically and shipped back to the manufacturer.

The IDU2 is equipped with a anti-theft system. Any unwanted movement of the merchandise/assets will be detected by the wireless readers and trigger an alarm. The missing merchandise/assets bearing RFID tag can be located via RFID reader with the built-in GPS+GIS+WSN communication modules (S232).

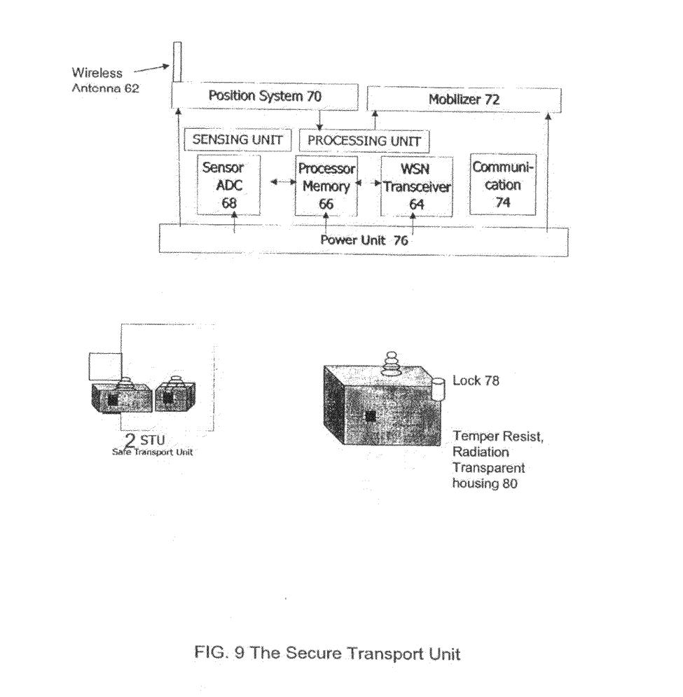

### FIG. 9 The Secure Transport Unit (STU) and the Sensor Node

A Secure Transport Unit (STU) is used to lockup the goods/documents in transit. The STU can be any size, from small box to large containers. Each STU is equipped with a temper-proved wireless lock (e.g. RFID) bearing an SSCC (Serial Shipping Container Code). Mechanism is also available to ensure the safety of the merchandise/article before and en-transit.

For antiterrorism and cargo tracking, the World Customs Organization (WCO) suggests that every country use UCR to resolve information management issues for international cargo logistics.

Upon completion of a purchase, an electronic tracking # (or UCR for exporting cargoes) will be routed to the shipper to signify the confirmation of the purchase This number will be linked to the SSCC code of the STU that holds the merchandise for delivery to the designated location. This tracking code will follow the cargo conveyance all the way until the cargo is received by the consignee and will allow the merchandise/cargo to be tracked real-time.

The components in the STU is listed below,

| | |
|---|---|
| The STU Sensor Node | 6 |
| Wireless Antenna | 62 |
| WSN transceiver | 64 |
| Microprocessor + memory. | 66 |
| Sensor module + AD converter | 68 |
| Can sense light, heat, bio-hazardous, chemical | 74 |
| hazardous, noise, Communication Module (GPRS/GSM, . . .) | |
| Location Finding Module | 70 |
| Mobilizer | 72 |
| | 74 |
| Power Unit | 76 |
| Non-reusable lock | 78 |
| Temper Resist, radiation transparent housing | 80 |
| Unique ISO SSCC(Serial Shipping Container Code) | |
| Can be any size, from small box to a container | |

A security Transport Unit is used to lockup the goods/documents in transit. The Transport Unit can be any size, from small box to large containers.

### The STU Sensor Node 6

In order to achieve what's mentioned in FIG. 1, an STU Sensor Node 6 is needed. FIG. 9 provides the details of the STU sensor node 6 of this invention. This STU Sensor Node 6 includes at least one wireless antenna 62, one WSN transceiver 64, one Microprocessor & memory 66, one sensor module +AD converter 68, allows sensing of combinations of light, heat, bio-hazardous substance, chemical hazardous substance, noise, vibration, acceleration, . . . etc The Location Finding Module 70, Communication Module (GPRS/GSM, . . . ) 74, Mobilizer 72, Power Unit 76, Non-reusable lock 78, Temper Resist, radiation transparent housing 80.

The power source 76 mentioned above can be a battery to provide power to the STU Sensor Node 6, The WSN transceiver 64 will serve to communicate with the other Sensor Nodes and gateway, coordinator, the microprocessor & memory 66 is used to conduct simple computation and memory storage. The sensor module +AD converter 68, comprised of various sensors to allow for sensing the combinations of light, heat, bio-hazardous substance, chemical hazardous substance, noise, vibration, motion, IR, radiation or acceleration, . . . etc. Alarms can be reported upon detection of any abnormal situation. The communication module 74 can compose of various communication IC: Global System For Mobile Communications (GSM), Code Division Multiple Access (CDMA), DCS Personal Communications Services (PCS), 3G (3rd Generation), and/or Wireless LAN (WLAN), . . . etc. The position system 70 composed of Global Positioning System (GPS), Asymmetric Global Positioning System (AGPS), Global Orbiting Navigation Satellite System (GLONASS), North Pole position system, or Galileo commercial position navigation system.

The temper resistant, radiation transparent housing 80 and the non-reusable lock 78 serve to ensure that there are no unknown tempering of the cargo during transit from the shipper to the customer. Each of the Secure Transport Unit is built with unique SSCC and is reusable.

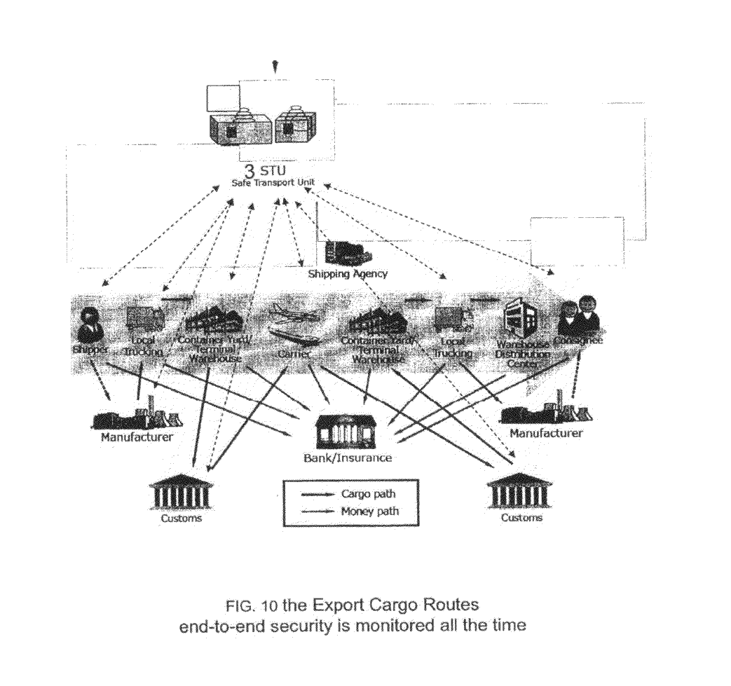

FIG. 10 Represents the Export Cargo Routes with Security Monitoring all the Time from the Shipper to the Customer.

Once the purchase contracted is signed, a UCR# will be issued, and the cargoes/merchandise will be locked in the STU and ship to the customer. The STU can be made of metallic alloy or any materials that can not be tempered but can be inspected with radiation, X-ray and alike. This STU can be scanned to ensure no weapon, nor hazardous material is enclosed.

With Satellite and the communication technology, the STU can be monitored real-time, so all parties or concern, the shipper, the forwarder, the shipping agent, the Customs agent, carriers, warehouse keeper, and the consignee can get access to the location and status of the cargo anytime. Should there be any unusual situation, the Sensor Node will report the abnormality to the information center (base station, here is our UIS) so proper measure can be taken promptly. After each trip, the journey data stored in the memory of the Sensor Node can be dumped and erased, but the lock has to be destroyed before the STU can be opened.

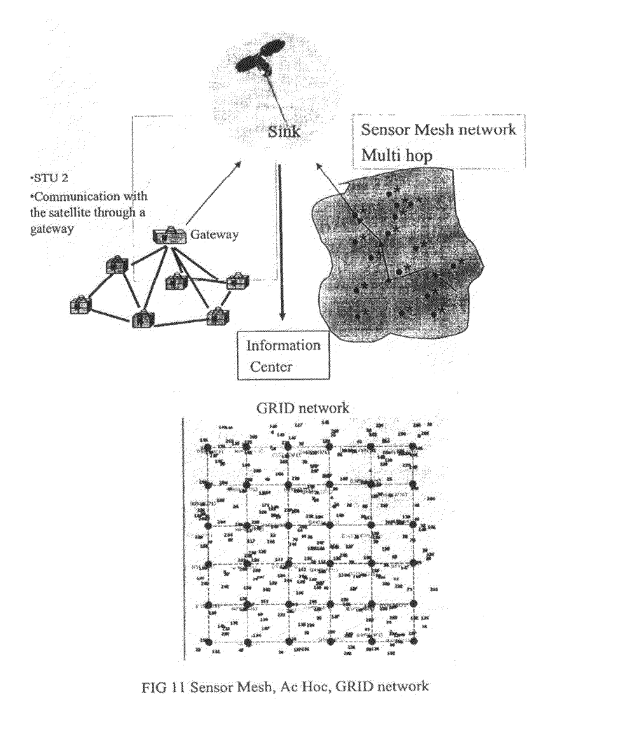

### FIG. 11 The WSN Mesh Network and Grid Network

The Sensor Node on the STU can be incorporated into a Sensor Network with the other Nodes in the vicinity utilize an mesh network protocol (Zigbee, Ad Hoc, GRID, . . . etc). Signals can be transmitted back to the base station via multi-hopping through the other Sensor Nodes. The Nodes can usually find the shortest rout and calibrate themselves to optimize the quality of signal transfer. Should there be any additional/removal/malfunctioning of any Node, the network will recalibrate for their routing. During transit of the cargoes, the radios are communicated with the RFID label on the goods/cargos to ensure security of the cargo logistics.

The STU Communicate with Satellite Through a Gateway/Telematics

When the cargo are in remote area or on the vessels, sensor signals can be communicated with the base station through a satellite after multi-hoping. The STUs can communicate to satellites (low orbital) through a telematics/or gateway units on the transportation vehicle/Vessels (truck or ships), which can directly communicate with the satellite. The telematics is communicated with satellite to monitor the goods/cargoes real time during transit to ensure its secure delivery.

### WCO Initiative and UCR

Various peoples are involved in the International trading cargo transport process. Low container inspection rate (˜2%), creates security problems and increase in the need for international security.

Current international trading process will affect the cargo logistics facilitation. It is difficult to trace the missing cargoes owing to the difference in the numbering systems. This created difficulty for Customs audit and cargo security.

Once the order is placed and goods/cargoes packed in the box, the unique tracking number (or UCR) will be recorded/linked to the electronic locks of the Transport Unit and thus the combination of RFID/barcode +UCR number can be tracked real time during the transit of the goods/cargo from shipper to the consignee.

UCR (Unique Consignment Reference) is a number set between shipper and consignee during contract signing. This unique reference number will be attached on the cargo and follow the cargo conveyance all the way until the cargo is received by the consignee.

For antiterrorism and cargo tracking, WCO suggest every country use UCR to resolve information management issues. WCO does not specify the coding method of UCR Combination of UCR and RFID can ensure global security and facilitation environment? In this invention, the cargo logistics are closely tracked with the combination of UCR+SSCC+RFID, utilizing satellite+WSN+RFID communication.

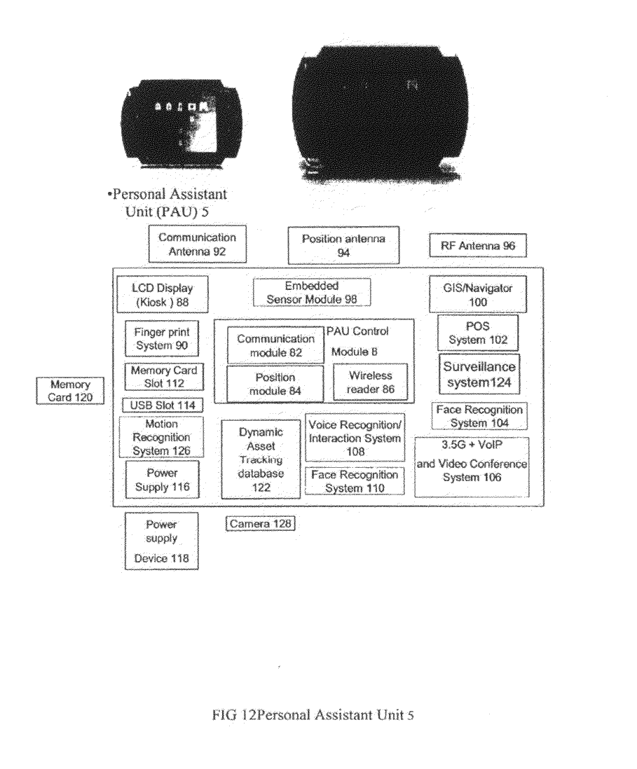

### FIG. 12 The Personal Assistance Unit (PAU)

A smaller unit of IDU can be used for customize personal assistance (PAU). The unit can be used at offices/or at any private space to assist business/individual organizing/their tasks, managing their assets, documents, information, and all their ordering needs. The PAU is a miniaturized unit of the IDU. Below is the list of components for PAU,

| | |
|---|---|
| Personal Assistant Unit (PAS) | 5 |
| PAS Control Module | 8 |
| Wireless reading module | 86 |
| Communication module | 82 |
| Position module | 84 |
| Power supply module | 116 |
| RFID reader antenna | 96 |
| Communication antenna | 82 |
| Position antenna | 94 |
| Embedded sensor Module | 98 |
| Memory Slot | 112 |
| Power supply Device | 118 |
| LCD display(Touch screen Kiosk) | 88 |
| Memory Card | 120 |
| Geographic Information System/Navigator | 100 |
| Dynamic Real Time Asset Tracking Database | 122 |
| POS System | 102 |
| Surveillance system | 124 |
| Motion Recognition/Commanding System | 126 |
| Face Recognition System | 104 |
| Voice Recognition/commanding System | 108 |
| Camera | 128 |

A PAS Control module is needed. FIG. 12 provides the details of the PAS module 5 of this invention. This PAS 5 includes at least one wireless reading module 86, one communication module 82, one position module 84, one power supply module 116, one RFID reader antenna 96 and a position reader 94. This system is to serve as personal assistant, to provide asset management, and other user's need.

The power supply module 116 mentioned above is connected to an external power supply 118 to provide power to the PAS 5. The wireless reader module 86 is connected to the RFID antenna 96 and power supply 116, to read one or more external RFID signals from RFID tags. The communication module 82 is connected to power supply 116, and antenna 92, to transmit the RFID signal information, the position module 84 is connected to position antenna 94 and power supply 116, the signal is transmitted to position the PAS 5, the PAS 5 is a movable device.

The communication module 82 can compose of various communication IC: Global System For Mobile Communications (GSM), Code Division Multiple Access (CDMA), DCS Personal Communications Services (PCS), 3G (3rd Generation), and/or Wireless LAN (WLAN), . . . etc. The position module 84 composed of Global Positioning System (GPS), Asymmetric Global Positioning System (AGPS), Global Orbiting Navigation Satellite System (GLONASS), North Pole position system, or Galileo commercial position navigation system.

The position module mentioned here can also be a combination of GPS, wireless network to provide the location information of the assets.

The PAU allows people to locate the right asset, provide information about the current physical status of an asset, and keep an information history of an asset. All the items they need to manage can bear a RFID.

Their PAU can be equipped with a talking Kiosk 88 building with camera 128 and mic for motion/voice commanding 126 108. They can request the system to give them information regarding the location of their assets, the weather and stock market situation, the location of other members, the status of goods they ordered, print any images/documents they want with voice, keep track of their concerns and preferences, summarize their routine activities for them, analyze/manage the resources for them, alarming them for their health conditions, the system can also be linked to the surveillance system and help them monitor for any unwanted intrusion hazardous event. A robot build in with sensors can also be used to take care of the chores including organizing assets/books/documents/equipments to designated place. Cleanup areas routinely. The robotic devices can accomplish any of the functions mentioned in this system or to extend the functions.

In short, with the support of PAS, the user can ensure, monitor and tracks asset movements and status in real-time; identify deviations from expected asset location or condition; trigger exception-based alerts or specific warning notifications; accesses historical data to identify and eliminate operational bottlenecks; validate asset utilization, maintain asset inventories and tighten internal controls

And much more.

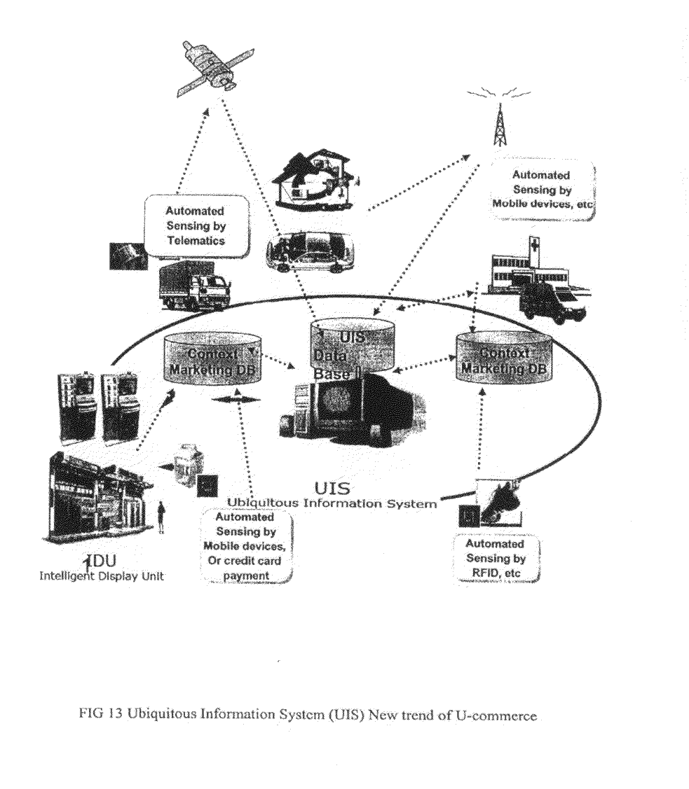

### FIG. 13 Representation of the Ubiquitous Information System (UIS)

The Ubiquitous Information Systems (UIS) 4 is the central information control system used here to manage all the C2M, M2M, C2M2C, C2M2M2C interaction between users and any units of this system or between the units in this system and/or with the other communicational devices.

There are three major functions of the UIS

1. The UIS is used to Manage/update all the displaying information, video for the product demonstration, price, and promotional activities . . . etc real-time. Manage the databases for commercial/personal information including but not limited to the user's information, clicking count, orders, payments. The system is connected with banks for ease of monetary exchange to enable payment, loans, and money transfer during transaction. The UIS is also used to perform logistics management/tracking, including but not limited to the shipments information, logistics/reverse logistics, product pedigree, and Customs information, . . . etc. The system issues unique tracking number/or UCR for the goods/cargoes upon order is received. The system is linked to the logistics service agents, and provide commands to specify the products, its package or desired gift wrap, shipped to a desired location. The tracking number/UCR is then logged in the systems' database and initiate a real-time tracking process. The system can provide additional cargo logistics and supply chain management service, including but not limited to: management for invoice, inventory control and reordering, vendor management, reverse inventory and recycling, the system is connected to logistics express service and can handle global shipment to anywhere in any form. International single window and global logistics center.

The UIS can be linked to the national or international Single Window/e-government/e-trading/e-traffic platform and serve as a global ordering & logistics service center. The system can provide intelligent Information routing/connection with national governmental and non-governmental platforms.

The system can provide international Customs declaration/licensing services when export process is involved. The licensing service can include certificate of origin, certificate for intellectual property, a mark for AEO (authorized economic operator) if the manufacturer has been certified, and other certification might be involved . . . etc. Then a tracking process through the entire process is conducted. The manufacture process information of the goods/or the pedigree can be recorded with certain identification (RFID, barcode . . . ) and linked to the same database. The users/concerned party can track the location and status of the goods and the pedigree of the goods any time, anywhere during transit.

### Marketing Analyses/User Behavior Study

The UIS can provide marketing analyses and consumer behavior study. People's feedback/showing interest (CRM), sales, and inventory information on a particular merchandise are collected real-time and maintained on a database. These information will be used for future marketing analyses/users behavior study, to be feedback to the manufacturer/management for revising/fine-tuning future marketing approach in order to provide a better service.

Promotion item of their preference can also be sent to them via short message, their prefer interaction mechanism will be triggered preferentially at the IDU with personalized greetings when they approaches the IDU. The users' concerns/request expressed to the IDU regarding the merchandise/services will be collected and added to future product demonstration. Their questions will also be summarized to better serve them.

As shown in FIG. 13, a context analyses method is employed for consumer behavior analyses. In this methods, the consumer behavior are collected whenever they use mobile device or credit card to pay for any merchandise/services. These data will be stored in the database. The market analyses is conducted via grouping the context based on population, location, time, or other parameters. Consumer Behavior Study is the study of the processes involved when individuals or groups select, inquiring, purchase, use, or dispose of products, services ideas, or experiences to satisfy needs and desires. The consumer's behavior pre-purchase, purchase, and post-purchase can shine some light to the manufacturer for future product development/promotion.

Information Security measures: The database is guarded with top security from any form of intrusion. The people's privacy will also be preserved.

The system can be used anytime, at any location, including but not limited to following places: exhibition place, commercial, entertainment, hotels, restaurants, government or non-governmental places, sea, land, air transportation and their stations, medical treatment locations, residents, sports facilities, streets, underground streets, sub, factories, rural, wild area . . . etc.

Although the invention has been shown and described with respect to a certain embodiment or embodiments, equivalent alterations and modifications may occur to others skilled in the art upon the reading and understanding of this specification and the annexed drawings.

What is claimed is:

1. A Secure Commerce and Asset/Supply Chain Management system comprising:
an Intelligent Display Unit (IDU, 1);
an Ubiquitous Information System (UIS, 2);
a Secure Transport Unit (STU, 3); and
a Personal Assistant Unit (PAU, 4).

2. The system of claim 1, wherein:
the Intelligent Display Unit (IDU, 1) provides direct customers/users interaction.

3. The system of claim 1, wherein:
the Ubiquitous Information System (UIS, 2) works at the backend to provide all the digitized information and to record customer's behavior real time for future marketing purpose;
once an order is placed at the IDU (1), the UIS (2) receives the order information, issues a UCR both to the customer at IDU (1) and a route to the shipping agent, and the merchandises/cargoes are then locked in the STU (3), shipped on the road and tracked real-time with satellite+GPRS+WSN or the other available wireless communication technologies until they reach the designation.

4. The system of claim 1, wherein:
the PAU (4) can assist individual/office asset management, and can also access the other units mentioned here for any purchase/tracking needs.

5. The system of claim 1, wherein the IDU (FIG. 3) comprises at least selected ones of: wireless reading module (10), communication module (12), position module (14), power supply module (16), RFID reader antenna (18), communication antenna (20), position antenna (22), power supply device (30), LCD display (32), memory slot (320) for memory Card (322), Geographic Information System (34), Dynamic Real Time Merchandize Tracking Database (36), POS System (38), Anti-Theft police network system (40), Motion Recognition/Commanding System (44), Face Recognition System (46), Voice Recognition/commanding System (48), Printer/User ID generator (50), Embedded sensor/computer/communicator (52), and Return/Recycling System (54).

6. The system of claim 5, further comprising a display control system (FIG. 2) comprising at least one wireless reading module (10), one communication module (12), one position module (14), one power supply module (16), one RFID reader antenna (18), a communication antenna (20), and a position antenna (22).

7. The system of claim 6, wherein the display control system (FIG. 2) is used to control the interaction with the users, manage the merchandise, communicate with the UIS, and the other machines as needed to fulfill the user's requirements.

8. The system of claim 6, wherein:
the power supply module (16) is connected to an external power supply to provide power to the wireless reader module (10);
the wireless reader module (10) is connected to the RFID antenna (18) and power supply (16), to read one or more external RFID signals from RFID tags; and
the communication module (12) is connected to power supply (16) and to the antenna (20), to transmit the RFID signal information, the position module (14) is connected to the position antenna (22) and to the power supply (16).

9. The system of claim 6, wherein:
the communicational module (12) comprise a communication module (IC) selected from the group consisting of Global System For Mobile Communications (GSM), Code Division Multiple Access (CDMA), DCS Personal Communications Services (PCS), 3G (3rd Generation), and Wireless LAN (WLAN).

10. The system of claim 6, wherein:
the position module (14) comprises one or more of Global Positioning System (GPS), Asymmetric Global Positioning System (AGPS), Global Orbiting Navigation Satellite System (GLONASS), North Pole position system, or Galileo commercial position navigation system, and may also be a combination of GPS and wireless network to provide the location information of the merchandise/assets/IDU.

11. A Secure Commerce and Asset/Supply Chain Management method comprising:
providing an Intelligent Display Unit (IDU, 1);
providing an Ubiquitous Information System (UIS, 2);
providing a Secure Transport Unit (STU, 3); and
providing a Personal Assistant Unit (PAU, 4).

12. The method of claim 11, wherein a person (customer) at a public or private space engages with the IDU, is greeted with personalized information, and starts a C2M interaction.

13. The method of claim 12, wherein the C2M interaction can be accomplished by typing a keyboard, by sending a message from the person's mobile/wearable devices, by speaking to the display, by touching the displayed merchandise/service, by touching a screen, or by signaling with movements of his/her body.

14. The method of claim 13, wherein the display automatically demonstrates the merchandize/service of interest, with various views, functions, and aspects of the merchandize/service, addresses the customer's questions/concerns, or engage the customer into a virtual experience of the merchandise/service.

15. The method of claim 14, wherein: payment is completed by automatic deduction from the user's credit card/bank account/e-wallet, or mobile banking account with credit cards/smart cards, mobile devices, . . . etc.

16. The method of claim 15, further comprising:
incorporating a POS (point of sale) system into the display unit;
wherein the system can take orders from the person and complete the money transaction with the POS system.

17. The method of claim 15, wherein: upon completion of the transaction, receipts/tickets/unique tracking IDs (or Unique Consignment Reference number for export goods) are issued in electronic form, which can be transmitted to the mobile device carried by the person, and/or be printed out by a printer attached to the system.

18. The method of claim 17, further comprising:
placing the merchandise in a secure transport unit, locked with a tamper-proved wireless locking mechanism carrying a non-reusable, unique ID (RFID or UCR), and delivering the merchandise to the user's desired location.

19. The method of claim 18, further comprising:
dispatching a taxi to a location where the reservation order is issued or another requested location.

20. The method of claim 18, further comprising:
reserving a hotel room with the user's name.
